(19) United States
(12) Patent Application Publication
(10) Pub. No.: US 2022/0133069 A1
(43) Pub. Date: May 5, 2022

(54) Consumption Tracking Wine Glass

(71) Applicants: Tonya Roth, Louisville, TN (US); James Cohron, Louisville, TN (US)

(72) Inventors: Tonya Roth, Louisville, TN (US); James Cohron, Louisville, TN (US)

(21) Appl. No.: 17/204,211

(22) Filed: Mar. 17, 2021

Related U.S. Application Data
(60) Provisional application No. 63/108,923, filed on Nov. 3, 2020.

(51) Int. Cl. A47G 23/16; A47G 19/22; G01C 9/02; G01F 22/00; G01G 19/52; G01G 19/40

(52) U.S. Cl. CPC A47G 23/16; A47G 19/2205; G01C 9/02; H04L 67/12; G01G 19/52; G01G 19/40; A47G 2200/226; G01F 22/00

(57) ABSTRACT

The present invention relates generally to the field of alcohol consumption monitoring. More specifically, the present invention relates to a consumption tracking beverage container which allows a user to track the amount of wine or alcohol that they consume over time from said container. Further, the container may be wirelessly paired to a mobile application on a smart device to allow the user to analyze his or her alcohol consumption trends and patterns over time.

### CROSS-REFERENCE TO RELATED APPLICATION

The present application claims priority to, and the benefit of, U.S. Provisional Application No. 63/108,923, which was filed on Nov. 3, 2020 and is incorporated herein by reference in its entirety.

### FIELD OF INVENTION

The present invention relates generally to the field of alcohol consumption monitoring. More specifically, the present invention relates to a consumption tracking wine glass which allows a user to track the amount of wine or alcohol they consume over time for weight loss, drink management, health management, legal compliance or any other purposes via a weight sensor embedded into the wine glass. Further, the wine glass is comprised of a mobile application/software application that allows a user to analyze consumption trends and patterns over time when paired to the wine glass via a wireless communication module. Further, the mobile application/software may be comprised of an algorithm or artificial intelligence which recommends consumption amounts to a user to meet specific consumption goals, and that may also alert a user and/or an individual who is serving the user that the user has consumed too much alcohol. Accordingly, the present disclosure makes specific reference thereto. Nonetheless, it is to be appreciated that aspects of the present invention are also equally applicable to other like applications, devices and methods of manufacture.

### BACKGROUND

Alcohol consumption holds an important role in social engagement and bonding, and as such alcoholic beverages are a routine part of life for many individuals. However, regular and/or excessive consumption of alcohol may cause numerous health issues, including death. For example, alcohol consumption contributes to more than 3 million deaths each year globally, and the improper use of alcohol is responsible for approximately 5.1% of the global burden of disease. As such, an individual may choose to track the amount of wine or other alcoholic beverages that he or she consumes for weight loss, legal compliance or general health purposes. Further, many dietitians and other healthcare professionals may ask patients to record the number of ounces of alcohol that they consume to track their calories for weight loss or other medical reasons. Similarly, some individuals prefer to track their alcohol consumption for the purposes of drink management or blood alcohol level monitoring for situations such as parole or staying under the legal blood alcohol limit while operating, for example, a motor vehicle.

Some individuals may manually measure the quantity of alcohol that they consume based on the capacity of the bottles, cans or glasses that they use to consume the alcohol in order to keep track of their total alcohol consumption. However, such individuals frequently forget to keep track of each and every drink (or portion thereof) that they consume, which may lead to inaccurate alcohol consumption calculations and records. This is undesirable for health management and weight loss purposes, as it is extremely important to accurately monitor the amount of alcohol consumed when engaging in such activities.

Further, when utilizing conventional wine glasses, it is oftentimes difficult to determine how much wine has been poured and consumed, as wine glasses vary widely in shape and size. Some modern wine glasses are comprised with etched measurement marks which allow a user to measure the wine consumed in the glass manually via observing the measurement increment that corresponds with a level of wine within the glass. However, this manual method of quantifying the amount of alcohol poured or consumed may be done incorrectly or inaccurately by users, especially while intoxicated, which leads to inaccurate alcohol consumption tracking results. Additionally, the measurement marks are often etched into the glass at specific fixed increments, such as 4, 8, and 12 ounces, which may be difficult to accurately measure if the amount of alcohol consumed is in between the etched increments. Further, individuals may simply forget to track the amount of alcohol/wine that they consume, or may simply feel as though wine glasses with measurement increments are tacky, distasteful, and embarrassing and may choose not to use the same.

Therefore, there exists a long felt need in the art for an alcohol consumption tracking device that enables a user to automatically measure the amount of wine or other alcoholic beverages consumed by the user. There is also a long felt need in the art for an alcohol consumption device that enables a user to accurately monitor their alcohol consumption and analyze trends and patterns related to their alcohol consumption for health management, weight loss and other purposes. Additionally, there is a long felt need in the art for a consumption tracking wine glass which automatically measures the exact quantity of alcohol consumed by the user via the glass, and that does not rely on a user's manual observation and consumption calculation. Moreover, there is a long felt need in the art for a consumption tracking wine glass that notifies a user to avoid drinking further if impaired due to excessive consumption, and that ensures that the user is not unintentionally over served at a party or occasion. Finally, there is a long felt need for a consumption tracking wine glass that is relatively inexpensive to manufacture and both safe and easy to use.

The subject matter disclosed and claimed herein, in one embodiment thereof, comprises a consumption tracking glass or container that allows a user to accurately track and record his or her alcohol consumption via the container, and analyze consumption trends over a period of time. The container may be in the form of a wine glass that is comprised of a shaped body portion for holding an alcoholic beverage that is supported by both a stem and a base. The base is comprised of a weight sensor that measures and records the weight/volume of alcohol added to the body portion of the wine glass automatically. The base may also be comprised of a small wireless communication module that allows the container to send the weight/volume information to a compatible smartphone application, wherein the smartphone application stores the received information and allows the user to analyze the information via a plurality of patterns, graphs and trends. In addition, the base or the stem of the container may comprise a relatively small reset button that allows a user to reset the weight sensor.

In this manner, the consumption tracking wine glass of the present invention accomplishes all of the forgoing objectives, and provides a relatively easy to use, automatic and accurate method of measuring the exact amount of any alcoholic drink consumed by the user. The trackable wine glass of the present invention is also user friendly, inasmuch as the glass comprises a weight/volume sensor which automatically and accurately measures the exact amount of alcohol consumed without the need for additional effort on the part of the user. Additionally, the compatible smart device application/software application allows the user to monitor his or her alcohol consumption in both real-time, and over prolonged periods of time to analyze trends and patterns for the purposes of weight loss, alcoholic drink management, legal compliance and to better understand the user's habits.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a consumption tracking container that allows a user to accurately track and record wine/alcohol consumption via the container. In a preferred embodiment, the container is a wine glass having each of a body, a stem and a base. The base is further comprised of a weight/volume sensor that calculates and records the weight and/or volume of alcohol added to the container. More specifically, the weight sensor is preferably embedded in the base at the approximate geometric center of the glass, and is configured to dynamically measure the weight/volume of the alcohol/wine in the glass and to report the real time weight/volume information to the user via a related mobile application/software. Additional embodiments of the container may further comprise an inclinometer or clinometer for measuring the angle of slope of the container to adjust for the fact that the container may not be on a completely horizontal surface and to ensure that the correct weight and/or volume of alcohol within the glass is recorded. Further, the stem of the container may also be comprised of a control button that is in communication with the weight/volume sensor and allows a user to reset the weight/volume sensor to zero, for example, to begin a new consumption tracking session or for calibration purposes.

The base may also be comprised of a wireless communication module that is in electrical communication with the weight/volume sensor. The module is used to send the collected weight/volume information to a compatible smartphone application via Bluetooth/Wi-Fi. Alternatively, the information may be associated with a scannable QR code/barcode that can be scanned by a smart device for pairing, wherein the smartphone application then stores the received information and displays it to a user in the form of patterns, trends, and graphs that show consumption trends with a timestamp and the weight/volume of alcohol consumed. The paired smartphone application may be utilized by a user, a third party such as spouse or caretaker, law enforcement/parole officer or any other individual who may have interest in knowing the amount of alcohol that is or was consumed by the user.

The smartphone application may also display the weight of alcohol/wine consumed in multiple different units, such as grams, milligrams or ounces, and the volume of the alcohol in milliliters or fluid ounces. The application may also be comprised of an artificial intelligence (AI) and/or algorithm that recommends alcohol portion size based on medical history of the user by converting the user's alcohol consumption into a visual representation, such as a graph, chart, etc., that identifies the quantity of the alcohol/wine that should be consumed to meet the user's weight loss or other objectives. The algorithm/AI may also consider a plurality of other factors in determining the appropriate portion of alcohol/wine to recommend for consumption by the user, such as comparing the weight loss objective or amount inputted by a user to the weight of alcohol/wine consumed by the consumer, local blood alcohol/DUI laws, parole restrictions, etc. As such, the AI/algorithm may provide further feedback to encourage the user to limit his or her consumption of alcohol/wine.

In a further embodiment of the present invention, a method for accurately measuring alcohol or wine served in a wine glass is disclosed. The method is comprised of the initial step of measuring and recording the weight and/or volume of an alcoholic beverage poured into the wine glass via a weight sensor, and then transmitting the recorded weight/volume information in the form of a wireless communication signal to a paired smartphone application. Upon receipt, the received information may be recorded, analyzed and/or displayed. For example, the display may illustrate trends, recommendations and/or warnings based on the recorded consumption information and the medical history inputted by the user.

The consumption tracking wine glass of the present invention is particularly advantageous because it enables users to better track the amount of wine/alcohol consumed without any additional labor or the potential for miscalculations. The device also encourages and recommends healthy drinking habits for users, as well as further enabling a user to accurately track their alcohol consumption for purposes of weight loss, drink management, legal compliance and to obtain a better overall understanding of the user's drinking habits. The device further ensures that individuals are not unintentionally over served at a dinner party or other function and allows third parties, such as dietitians, doctors, family members, caretakers, law enforcement/parole officers, etc., to readily check the drinking pattern/status of the user via the smartphone application.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one potential embodiment of the consumption tracking wine glass of the present invention in the form of a red wine glass in accordance with the disclosed architecture;

FIG. 1B illustrates a perspective view of an alternative potential embodiment of the consumption tracking wine glass of the present invention in the form of a white wine glass in accordance with the disclosed architecture;

FIG. 1C illustrates a perspective view of a further potential embodiment of the consumption tracking container of the present invention in the form of a beer pint glass in accordance with the disclosed architecture;

FIG. 1D illustrates a perspective view of a further potential embodiment of the consumption tracking container of the present invention in the form of a snifter glass in accordance with the disclosed architecture;

FIG. 1E illustrates a perspective view of one potential embodiment of the consumption tracking container of the present invention in the form of a highball glass in accordance with the disclosed architecture;

FIG. 1F illustrates a perspective view of one potential embodiment of the consumption tracking container of the present invention in the form of a champagne flute in accordance with the disclosed architecture;

FIG. 2 illustrates a perspective view of one potential embodiment of the smartphone mobile application displaying various features of the consumption tracking container of the present invention in accordance with the disclosed architecture;

FIG. 3 illustrates a flow diagram of a method of using the consumption tracking wine glass and smartphone application of the present invention to enable a user to accurately monitor and analyze his or her consumption of alcoholic beverages in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an alcohol consumption tracking system that enables a user and others to automatically measure, record and analyze the amount of alcoholic beverages consumed by the user, and that does not rely on a user's manual observation and consumption calculation. More specifically, there is a long felt need in the art for an alcohol consumption tracking system that enables a user to accurately monitor his or her alcohol consumption, and analyze trends and patterns related to the alcohol consumption for purposes of health management, weight loss, legal compliance, etc. Moreover, there is a long felt need in the art for an alcohol consumption tracking system that notifies a user to avoid drinking further if impaired due to excessive consumption, and that ensures that the user is not unintentionally over served at a party or occasion. Finally, there is a long felt need for a consumption tracking wine glass that is relatively inexpensive to manufacture and both safe and easy to use.

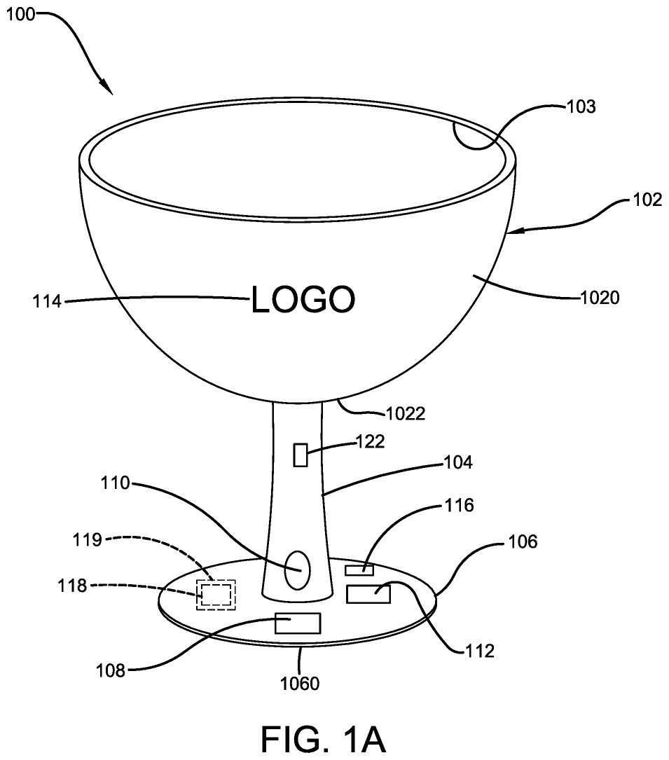

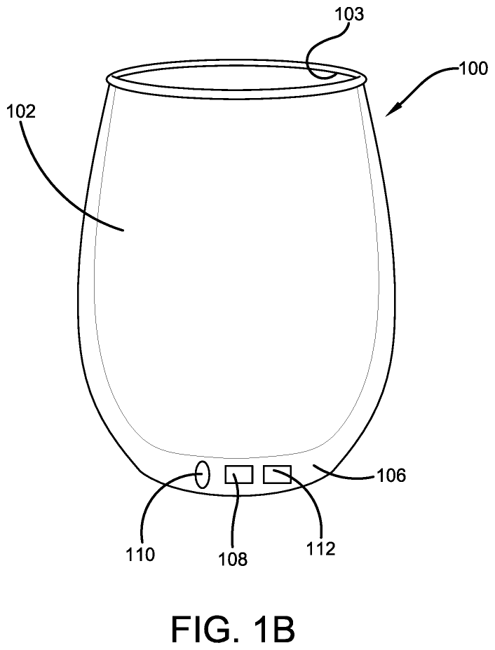

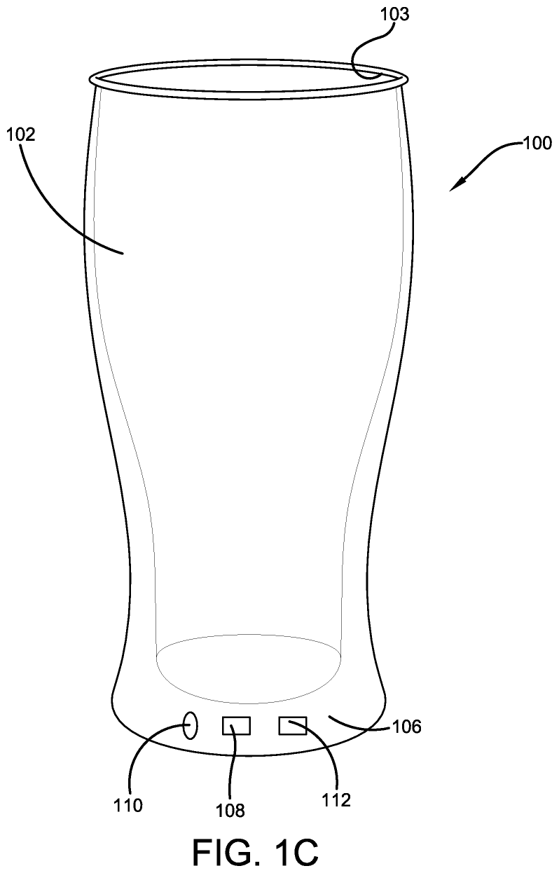

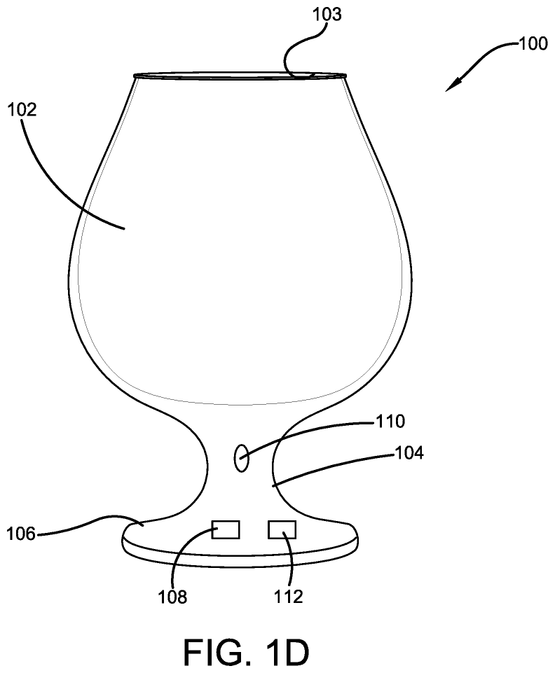

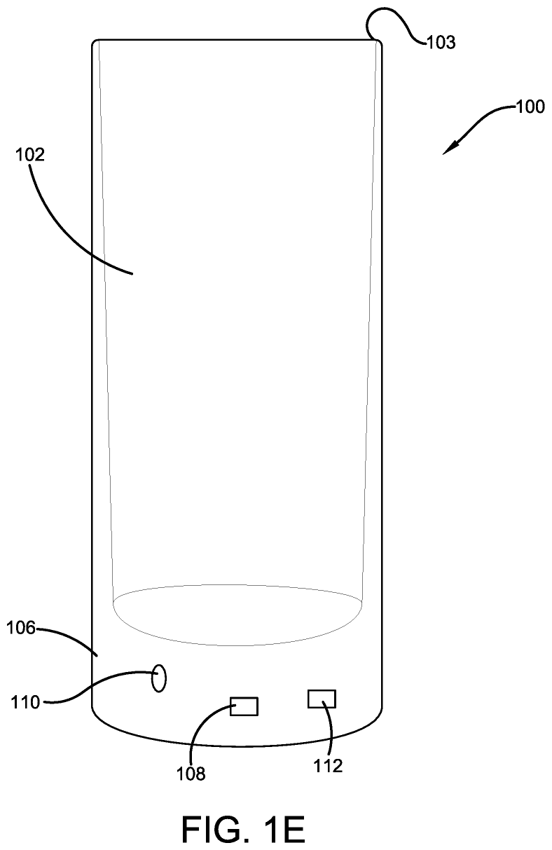

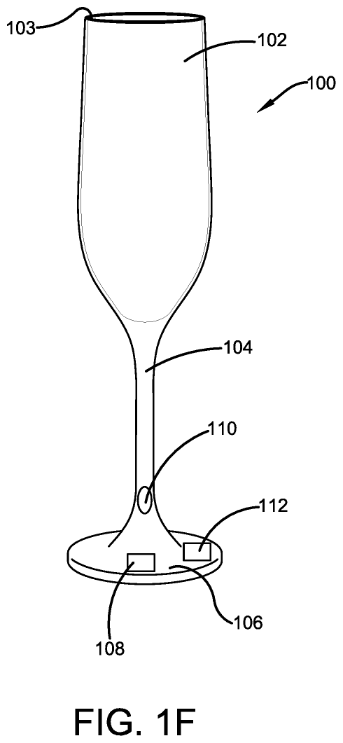

Referring initially to the drawings, FIG. 1A illustrates a perspective view of one potential embodiment of the consumption tracking wine glass 100 of the present invention in the form of a red wine glass in accordance with the disclosed architecture. More specifically, the wine glass device 100 is comprised of an elongated, generally oval shaped body portion 102, a stem 104 and a base 106. The body portion 102 is comprises of a continuous sidewall 1020 and a bottom 1022 forming an interior cavity 103 for receiving an alcoholic beverage such as, but not limited to, wine, beer, liquor, etc., or any other liquid (i.e., non-alcoholic). In a preferred embodiment, the body portion 102 is comprised of a glass material, such as leaded crystal glass, lead-free crystal glass, hock glass, mineral-infused glass, and/or titanium infused glass, wherein any portion of the body 102 or glass may be transparent, semi-transparent (e.g. frosted), or opaque.

It should be also be appreciated that the container or wine glass 100 may be comprised of any suitable shape and/or size including, without limitation, the following types of wine glasses: cabernet, burgundy, Bordeaux, zinfandel, pinot noir, chardonnay, white, red, champagne, cabernet sauvignon, port, madeira, sherry, sauternes, vintage, tulip, flute, alsace, renano, balloon, Bourgogne, grand balloon, hock, tumbler, dessert, etc., a number of which are more fully described below. Further, the body portion 102 may also be comprised of a promotional shape to coincide with a marketing, entertainment, or sporting event. Accordingly, the glass 100 may further be comprised of a plurality of logos 114, indicia, trademarks, geometric patterns, customizable colors and fonts, embroidery and prints and/or other images on the base 106, stem 104 or body portion 102.

In a preferred embodiment of the glass 100, the base 106 is generally circular in shape and has a weight or volume sensor 108 embedded or attached thereto, which is preferably located at the geometric center of the glass 100. The sensor 108 preferably measures the weight and/or volume of the alcoholic drink/liquid within the internal cavity 103 of the glass 100. Thus, as a user begins to consume alcohol/liquid from the glass 100, the weight and/or volume of the liquid is measured and reported to the smartphone application/software via a wireless communication module 112 that may also be attached to or embedded in base 106, or may alternatively be part of the weight sensor 108 itself. The communication module 112 allows the sensor 108 to communicate through a wireless connection, such as Bluetooth, RFID, NFC, Wi-Fi, etc., with a smartphone application/computer software, as more fully described below. Other components may also include a processor (not shown) to coordinate the various functions of the glass 100 and to communicate between the wireless communication module 112 and the weight sensor 108, and an inclinometer and/or clinometer 116 for measuring the angle or slope of the glass 100 if not positioned on a fully horizontal surface and correcting the weight and/or volume of alcohol within the glass 100 may also be present in the base 106. The bottom surface of the base 1060 may also be comprised of a battery 118 that powers the components of the glass 100, and a removable battery door 119 that allows a user to access/change the battery 118. In differing embodiments of the glass 100, the battery may be at least one disposable battery or a rechargeable battery in the form of an alkaline, nickel-cadmium, nickel-metal hydride battery, etc. such as any 3V-12 volts DC battery or other conventional battery that supply power to the glass 100. Throughout this specification the terms “battery”, “battery pack”, and “batteries” may be used interchangeably to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used. Further, one embodiment of the glass 100 may be comprised of a bottom surface 1060 that is comprised of a wireless charging surface that can be used to charge the components of the glass 100 via placing it on a wireless charger (not shown).

The stem 104 may be additionally comprised of a small touch sensitive or manual button 110 that is located near the base 106 on a portion of the stem 104 or on the base itself. The button 110 is in communication with the sensor 108 and allows a user to manually reset the weight sensor 108 to a zero value for calibration/re-calibration purposes. Also, the button 110 may be used to turn on/off the weight sensor 108 if pressed and held to conserve battery power and extend the battery life, or to turn the entire glass 100 on/off.

In a further embodiment of the invention, the glass 100 may further comprise a speaker 122 positioned along the stem 104 or base 106 that is also in communication with the sensor 108 and may be used to produce an audible sound indicating, for example, the weight/volume of the alcohol/wine present in the body 102 of the trackable glass 100. The speaker 122 may further receive a signal from the weight sensor 108 which causes the speaker 122 to produce an audible notification for the user and/or individual who is serving the user (e.g. a bartender) to be aware about the weight/volume of the alcohol/wine within the glass 100 and the amount of alcohol the user has already consumed in accordance with local blood alcohol laws and/or parole requirements of the user.

As noted above, in different embodiments of the device 100, the body portion 102 or the entire glass or container 100 may take on various shapes as shown in FIGS. 1B-1F. For example, FIG. 1B illustrates a perspective view of an alternative potential embodiment of the consumption tracking wine glass 100 of the present invention in the form of a white wine glass in accordance with the disclosed architecture. More specifically, the body 102 is in the general shape of a white wine-glass, and the glass 100 further comprises a base 106 and a weight sensor 108 that calculates, measures, and records the weight and/or volume of wine/other alcohol that is added to, or contained within, the glass 100. The base 106 and/or weight sensor 108 may also be comprised of, and in electrical communication with, a wireless communication module 112 that is connected via Bluetooth or other means to a mobile application/software, wherein the module 112 sends the recorded weight/volume information to the mobile application. In addition, the base 106 may also be comprised of a control button 110 that allows a user to reset the weight sensor 108 to zero.

FIG. 1C illustrates a perspective view of a further potential embodiment of the consumption tracking container 100 of the present invention in the form of a beer pint glass in accordance with the disclosed architecture. More specifically, the body portion 102 has a generally beer pint glass shape, and the container 100 further comprises a base 106 and a weight sensor 108 that calculates, measures, and records the weight and/or volume of wine/other alcohol that is added or contained within the container 100. The base and/or weight sensor 108 is in electrical communication with the wireless communication module 112 that is connected via Bluetooth or other means to a mobile application. The communication module 112 sends the recorded weight/volume information collected by the sensor to a compatible mobile application/software located remotely on a smartphone, smart watch, tablet, computer, server, etc. In addition, the body portion 102 or the base 106 may also be comprised of a control button 110 that allows a user to reset the weight sensor 108 to zero, as needed.

FIG. 1D illustrates a perspective view of a further potential embodiment of the consumption tracking container 100 of the present invention in the form of a snifter glass in accordance with the disclosed architecture. More specifically, the container 100 has a generally snifter shaped body 102, a stem 104 and a base 106. A weight or volume sensor 108 that calculates, measures, and records the weight and/or volume of wine/other alcohol that is added or contained within the glass 100 is located along the base 106, but may also be embedded or positioned along the stem 104. The weight sensor 108 is in electrical communication with a wireless communication module 112 that is connected via Bluetooth or other means to a mobile application on a smartphone, smart watch, table, computer, server or the like, as described more fully below. Additionally, the body portion 102, stem 104 or the base 106 may be further comprised of a small control button 110 that allows a user to reset the weight sensor 108 to zero, as needed.

FIG. 1E illustrates a perspective view of yet another potential embodiment of the consumption tracking container 100 of the present invention in the form of a highball glass in accordance with the disclosed architecture. More specifically, the container 100 is comprised of a generally highball glass shaped body 102, a base 106 and a weight and/or volume sensor 108 that calculates, measures, and records the weight and/or volume of wine/other alcohol that is added or contained within the container 100. The base and/or weight sensor 108 is in electrical communication with a wireless communication module 112 that may be positioned along the body portion 102, the base 106 or form part of the sensor 108 itself. The module 112 is connected via Bluetooth or other wireless communication means to a mobile application, and sends the recorded weight/volume information to the compatible mobile application/software. In addition, the base 106 may also be comprised of a control button 110 that allows a user to reset the weight sensor 108 to zero, as needed.

FIG. 1F illustrates a perspective view of yet another potential embodiment of the consumption tracking container 100 of the present invention in the form of a champagne flute in accordance with the disclosed architecture. More specifically, the container 100 is comprised of a generally champagne flute shaped body 102, a stem 104, a base 106 and a weight sensor 108, wherein the stem 104 is positioned between, and is attached to, each of the body 102 and the base 106. The weight sensor 108 calculates, measures, and records the weight and/or volume of wine/other alcohol that is added or contained within the body portion 102 of the container 100, and further comprises, or is in electrical communication with, a wireless communication module 112. The module 112 is connected via Bluetooth or other wireless communication means to a mobile application, and sends the recorded weight/volume information to the mobile application/software. The container 100 further comprises a control button 110 that is in communication with the sensor 108, and allows the user to reset the weight sensor 108 to zero, as needed. In a further embodiment, the remotely located mobile application/software can be used to reset the sensor 108 to zero by sending a reset instruction to the wireless communication module 112, which is in turn in communication with the sensor 108.

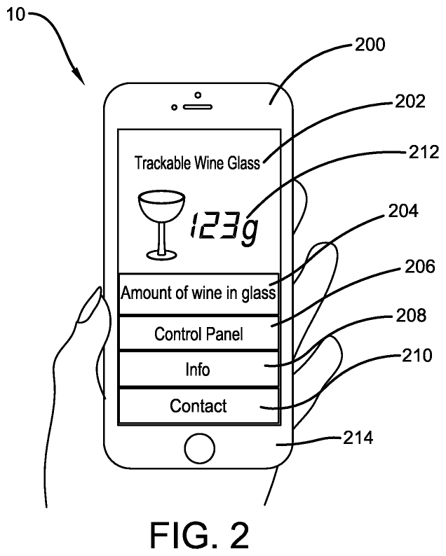

FIG. 2 illustrates a perspective view of one potential embodiment of the smartphone mobile application 200 displaying various features of the consumption tracking container 100 of the present invention in accordance with the disclosed architecture. More specifically, to enhance the utility of the trackable glass or container, the container 100 may be in wireless communication with a mobile application and/or software 200 that can be accessed via a smart device 10, such as a smartphone, smart watch, tablet, computer, server, etc. The application 200 is further comprised of a display interface 202 that displays the weight 212 of the alcoholic drink present in the paired glass 100. The weight 212 may be displayed in one of a plurality of units, such as grams, milligrams, or ounces, and the volume of the alcoholic drink can also be shown by displaying, for example, the text “Amount of wine/alcohol in glass” 204, wherein the volume is displayed in milliliters or fluid ounces. The application/software 200 may also be comprised of a control panel 206 that can be used for pairing the application 200 with a glass 100 using wireless communication means, such as Wi-FI, Bluetooth, NFC, RFID, etc., or by, for example, scanning a QR code/barcode scanner/RFID tag that may comprise any portion of the body 102, stem 104 or base 106 of the glass 100.

In a further embodiment, the application/software 200 may also be comprised of an information control 210 that displays the trends/usage patterns of the user's alcohol consumption in a graphical format along with recommendations for the user to track/alter their drinking habits. Such trends and consumption history can be viewed within the application and can also be downloaded in the form of a Portable Document Format (PDF) or Microsoft Word (MS Word) document which can be emailed to a user or a third party, such as a healthcare worker, probation officer, etc. The consumption records may also comprise a timestamp that may be associated with the graphs/trends, and that records the date and time of each consumption or alcohol. The user may also use the application 200 to create weekly or monthly profiles of multiple users that can be used for tracking the consumption of multiple users and comparing the consumption habits between the various users being tracked.

Additionally, the recommendations of the application/software 200 may be suggested by an algorithm/artificial intelligence 214 that considers one or more factors in determining the appropriate amount of alcohol/wine that should be consumed by a user, such as comparing the weight loss objective of the user to the calories or other ingredients of the alcohol/wine being consumed by the user. Further, the user may input their height, weight, and the alcohol percentage of the alcohol that they are consuming into the app 200, wherein the algorithm/AI 214 may then estimate the user's blood alcohol level to advise the user to stop consuming alcohol to stay in accordance with local blood alcohol content laws for purposes of operating a motor vehicle and/or parole requirements. The application/software 200 may further upload the recorded weight/volume information to a central server or onto a cloud sever (either public or private) corresponding to the profile of the user to allow a user to keep track of their consumption over a prolonged period of time. The user may also subscribe to a cloud storage service, and may receive recommendations from a medical service/medical professional or a dietician to maintain healthy drinking habits.

The application/software 200 may further comprise a “Contact” tab 210 that allows the user to contact a dietician, caretaker, family member, parole officer, medical professional etc. to share the recorded alcohol volume/weight information by sending a Short message service (SMS), Instant message (IM), cellular call or an interactive voice call. The application/software 200 may also provide a push notification to alert the user about the weight and/or volume of the alcoholic drink, whenever alcohol is poured into a paired glass or container 100, and may also alert the user of their estimated blood alcohol content.

It should be noted that the control button 110 of the trackable glass 100 can also be controlled by controls present within the interface 202 of the application/software 200. For example, in one embodiment of the present invention, the built-in speaker 122 of the trackable glass 100 can also be controlled and muted by the application/software 200. The application/software 200 may also store recorded information in the memory of the smartphone/smart device 10, wherein the information can later be retrieved on demand for displaying trends and analysis for the user.

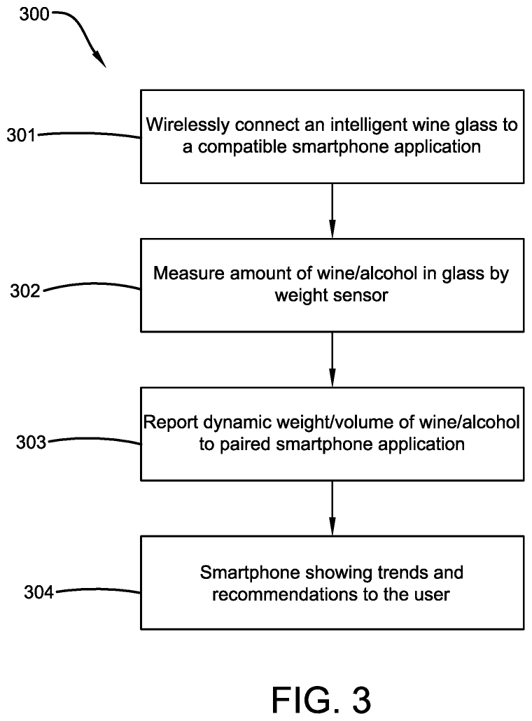

FIG. 3 illustrates a flow diagram of a method 300 of using the consumption tracking wine glass 100 and smartphone application 200 of the present invention to enable a user to accurately monitor and analyze his or her consumption of alcoholic beverages in accordance with the disclosed architecture. The method 300 begins at step 301 when a smart device 10 with the mobile application thereon is paired with the glass 100 such that a wireless communication channel is established via Bluetooth, Wi-Fi, NFC, RFID, etc. Through the wireless communication channel, the weight/volume of the alcoholic drink or other liquid poured in the body 102 of the glass 100 is then measured by a weight sensor 108 embedded in the base 106 of the glass 100 at step 302. Next, at step 303, the measurement is reported to the application/software 200 via the wireless communication module 112. Once received by the application 200, the recorded data is then shown and displayed on the interface 202 of the mobile application/software in 300 the form of graphs, trendlines, or other visual recommendations at step 304.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trackable wine glass”, “consumption tracking wine glass”, and “glass”, are interchangeable and refer to the consumption tracking wine glass 100 of the present invention.

Notwithstanding the forgoing, the consumption tracking wine glass/container 100 of the present invention can be of any suitable size and configuration as is known in the art without affecting the overall concept of the invention, provided that it accomplishes the above stated objectives. One of ordinary skill in the art will appreciate that the size, configuration and material of the consumption tracking wine glass/container 100 as shown in the FIGS. are for illustrative purposes only, and that many other sizes and shapes of the consumption tracking wine glass/container 100 are well within the scope of the present disclosure. Although the dimensions of the trackable wine glass/container 100 are important design parameters for user convenience, the consumption tracking wine glass/container 100 may be of any size or glass shape/type that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A beverage container for tracking consumption of an alcoholic beverage, the beverage container comprising:
a sidewall;
a bottom; wherein the sidewall and the bottom form an interior cavity for receipt of the alcoholic beverage; and
a sensor for sensing a weight or a volume of the alcoholic beverage contained within the interior cavity.

2. The beverage container of claim 1 further comprising a stem and a base, wherein the stem is fixedly attached to, and extends between, each of the bottom and the base.

3. The beverage container of claim 2, wherein the sensor is attached to the base.

4. The beverage container of claim 3 further comprising a reset button.

5. The beverage container of claim 4, wherein the reset button is in communication with the sensor.

6. The beverage container of claim 5 further comprising a wireless communication module.

7. The beverage container of claim 6, wherein the wireless communication module is in communication with each of the sensor and a smart device.

8. The beverage container of claim 7, wherein the smart device is one of a smartphone, a smart watch, a computer, a tablet and a remote server.

9. The beverage container of claim 8 further comprising an inclinometer in communication with the sensor.

10. An alcohol consumption tracking system comprising:
a beverage container;
a sensor;
a wireless communication module; and
a mobile application on a device that is remote from the beverage container.

11. The alcohol consumption tracking system of claim 10, wherein the beverage container is comprised of a continuous sidewall that forms an interior cavity for receipt of an alcoholic beverage, and further wherein the sensor senses a weight or a volume of the alcoholic beverage contained within the interior cavity.

12. The alcohol consumption tracking system of claim 11, wherein the sensor is in wireless communication with each of the wireless communication module and the mobile application.

13. The alcohol consumption tracking system of claim of claim 11 further comprising a stem and a base, wherein the stem is fixedly attached to, and extends outwardly from, the base to support the interior cavity.

14. The alcohol consumption tracking system of claim 13, wherein the sensor is attached to the base.

15. The alcohol consumption tracking system of claim 14 further comprising a reset button.

16. The alcohol consumption tracking system of claim 15, wherein the reset button is in communication with the sensor.

17. The alcohol consumption tracking system of claim 16 further comprising an inclinometer in communication with the sensor.

18. A beverage container for tracking consumption of an alcoholic beverage, the beverage container comprising:
a sidewall;
a bottom;
an interior cavity for receipt of the alcoholic beverage;
a stem;
a base; and
a sensor for sensing a weight or a volume of the alcoholic beverage contained within the interior cavity.

19. The beverage container of claim 18 further comprising an inclinometer in communication with the sensor.

20. The beverage container of claim 18 further comprising a reset button and a speaker, each of which is positioned on the base.
